(19) United States
(12) Patent Application Publication
(10) Pub. No.: US 2018/0229693 A1
(43) Pub. Date: Aug. 16, 2018

(54) Drive device for driving the rotation of a wiper arm, particularly for a panoramic windscreen

(71) Applicant: Valeo Systèmes d'Essuyage, Le Mesnil Saint Denis (FR)

(72) Inventor: Frédéric Giraud, Le Mesnil Saint Denis (FR)

(73) Assignee: Valeo Systèmes d'Essuyage, Le Mesnil Saint Denis (FR)

(21) Appl. No.: 15/932,230

(22) Filed: Feb. 16, 2018

(30) Foreign Application Priority Data
Feb. 16, 2017 (FR) 1751261

(51) Int. Cl. B60S 1/26; B60S 1/08

(52) U.S. Cl. CPC B60S 1/26; B60S 1/08

(57) ABSTRACT

The invention proposes a drive device (10) for driving a windscreen wiper, which comprises a bearing body (12), a drive shaft (20) which is mounted to rotate with respect to the bearing body (12), a guide housing (19) for guiding the drive shaft (20) in rotation about its axis (A1) which is pivot-mounted with respect to the bearing body (12) about an axis (A2) which is orthogonal to the axis (A1) of the drive shaft (20), a drive motor (16) for driving the shaft (20), a rack (30) and pinion (28) mechanism which causes the shaft (20) to pivot in order to vary the inclination of the axis (A1) of the shaft (20) with respect to the bearing body (12) according to the angular position of the drive shaft (20), characterized in that the drive motor (16) is supported by the guide housing (19).

### TECHNICAL FIELD OF THE INVENTION

The invention relates to a drive device for driving the two-directional rotation of a wiper arm and particularly a motor vehicle windscreen wiper arm.

### BACKGROUND OF THE INVENTION

The invention relates more particularly to a wiping system for a motor vehicle, particularly suited to wiping windscreens of complex surface, such as a panoramic windscreen.

A windscreen is said to be panoramic when it comprises lateral end portions which wrap around onto the sides of the vehicle, therefore having on each side a curved zone with very pronounced curvature.

With this type of windscreen, the problem that arises is that of being able to wipe effectively not only the front face of the glass, which generally has a low curvature, but also the lateral end portions thereof which have a very pronounced curvature.

The wiper comprises a structure able to force the wiper blade or blade rubber to be in contact over its entire length with the surface of the window. The structure also makes it possible to ensure that the contact pressure with which the wiper blade is pressed against the window is substantially uniform over the entire length of the blade.

To that end, the structure, whether of the articulated whippletree type or of the so-called “flat-blade” type is deformable in a plane which is substantially perpendicular to the window that is to be wiped and keeps the blade in this plane of deformation.

However, when the wiper travels across the window in its reciprocating rotary sweeping movement, the plane of deformation of its articulated structure does not remain rigorously perpendicular to the plane of the window that is to be wiped, because of the curvature of the window, and this means that the blade is in contact with the window at an angle that varies according to the position of the wiper.

One of the criteria that make it possible to obtain high-quality wiping lies in the angle of attack of the wiper and of the wiper blade, namely the inclination of the wiper at the point at which it is connected to the wiper arm with respect to the normal to the surface of the windscreen.

During a complete sweep in a direction extending from the wiper rest position to the extreme position, an improvement in wiping quality is obtained if it is possible to make this angle of attack of the wiper vary according to the zone of windscreen in which the wiper blade or blade rubber wiping the exterior surface of the windscreen is situated.

Numerous designs of wiper drive device that make it possible to vary the angle of attack of the wiper have already been proposed.

In particular, document FR-A1-2.753.942 discloses a system for wiping a window of a motor vehicle, of the type in which a drive arm is driven in reciprocating rotation in both directions by means of a drive device which comprises:
a bearing body;
a drive shaft which is mounted to rotate about its axis with respect to the bearing body;
a guide housing for guiding the drive shaft in rotation about its axis which is pivot-mounted with respect to the bearing body about an axis which is orthogonal to the axis of the drive shaft;
a drive motor for driving the two-directional rotation of the drive shaft about its axis;
a mechanism which causes the drive shaft to pivot in order to vary the inclination of the axis of the shaft with respect to the bearing according to the angular position of the shaft about its axis of rotation.

This known device guides the drive shaft in rotation about its drive axis and, on the other hand, brings about a variation in the inclination of the drive axis with respect to a reference axis that is fixed with respect to the bearing body and substantially perpendicular to the plane of the window, according to the angular position of the drive shaft about its axis.

By way of example, the mechanism is a cam mechanism which controls the pivoting of the drive shaft in order to vary the inclination of the axis of the drive shaft with respect to the reference axis according to the angular position of the drive shaft about its axis of rotation.

In such a wiping system, the drive motor acts on a linkage comprising a drive crank a control end of which is supported by the drive shaft to which it is rotationally connected.

It is an object of the present invention to propose a simple and compact drive device that can be readily adapted to suit all configurations of windscreen and particularly according to the shape of the windscreen and of the zones and space available for installing the drive device on the vehicle.

### BRIEF SUMMARY OF THE INVENTION

The invention proposes a device of the type mentioned hereinabove, characterized in that the drive motor is supported by the guide housing with which it is able to move in pivoting with respect to the bearing body.

Thus, the motor—such as, for example, an electric motor—is able to move in pivoting with the guide housing (to which it is firmly secured).

According to other features of the invention:
the guide housing houses transmission elements which convert the rotation of an output shaft of the motor into a rotational movement of the drive shaft about its axis;
the motor is an electric motor;
the output shaft of the motor is orthogonal to the drive shaft;
the axis of pivoting of the guide housing with respect to the bearing body and the axis of rotation of the output shaft of the motor are coplanar;
the mechanism comprises a pinion which is supported by the drive shaft to which it is rotationally connected, and a complementary rack which is supported by the bearing body;
the rack is fixed with respect to the bearing body;
the transmission ratio between the pinion and the rack varies according to the angular position of the pinion with respect to the rack.

### BRIEF DESCRIPTION OF THE FIGURES

Further features and advantages of the invention will become apparent during the reading of the detailed description that follows, for an understanding of which reference will be made to the attached drawings in which:

FIG. 1 is a side view of one embodiment of a drive device according to the invention, the various elements and components of which are illustrated schematically;

FIG. 2 is a view of the device of FIG. 1, from above;

FIG. 3 is a view of the device of FIG. 1, from the left side;

FIG. 4 is a view similar to that of FIG. 3, in which the guide housing has pivoted angularly through an angle α with respect to the bearing body;

FIG. 5 is a view similar to that of FIG. 2, in which the guide housing has pivoted angularly by the angle α with respect to the bearing body;

FIG. 6 schematically illustrates the orientation of the wiper blade or blade rubber with respect to the exterior surface of a window that is to be wiped in a first zone of this window;

FIG. 7 is a view similar to that of FIG. 6 illustrating the orientation of the wiper blade or blade rubber with respect to the exterior surface of a window that is to be wiped in a second zone of this window which is inclined with respect to the first zone;

FIGS. 8A to 8C are three diagrams illustrating three examples of alternative forms of design of the rack-pinion assembly;

FIGS. 9A to 9C are three diagrams illustrating the variation in the angular velocity of the pivoting of the guide housing according to the angular position of the windscreen wiper drive shaft, each diagram 9A to 9C being associated with the respective alternative form illustrated in diagrams 8A to 8C respectively.

### DETAILED DESCRIPTION OF THE FIGURES

In the remainder of the description, elements exhibiting an identical structure or similar functions will be denoted by the same references.

In the remainder of the description, longitudinal, vertical and transverse orientations indicated by the “L, V, T” trihedron in the figures will be adopted nonlimitingly. A horizontal plane is also defined which extends longitudinally and transversely.

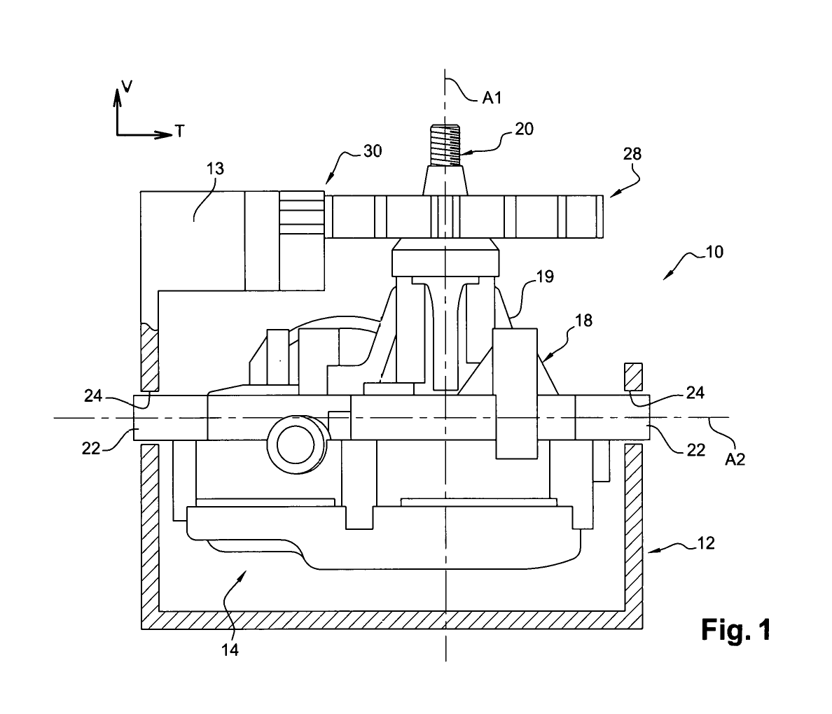

FIGS. 1 to 3 depict a drive device 10 for driving the reciprocating two-directional rotation, about an axis of rotation A1, of a wiper arm, not depicted.

The drive device 10 comprises a bearing 12, or bearing body 12, which is intended to be arranged and fixed for example near a window that is to be wiped, on the internal side of a bodywork panel (not depicted).

For driving the rotation of the wiper arm, the drive device 10 comprises a geared motor assembly 14 which is made up of an electric motor 16 and of a reduction gearbox 18.

The electric motor 16 comprises an output shaft, or armature shaft, not depicted in detail, which is able to rotate in both directions about the axis A3.

In the known way, the reduction gearbox 18 makes it is possible on the one hand to step down the rotational speed of the output shaft of the electric motor 16 and, on the other hand, to drive the rotation of a drive shaft 20, or output shaft, which is mounted to rotate in both directions with respect to the housing 19 of the reduction gearbox 18.

In addition, in the embodiment illustrated in the figures, the reduction gearbox 18 acts as an angle gear so that the axis of rotation A1 is orthogonal to the axis of rotation A3 of the output shaft of the electric motor 16.

The housing 19 of the geared motor unit 18 is thus a guide housing that guides the rotation of the drive shaft 20 which houses various transmission components and elements that convert the reciprocating two-directional rotation of the output shaft of the electric motor 16 about its axis of rotation A3 into a reciprocating two-directional rotational movement of the drive shaft 20 about its axis A1.

According to the teachings of the invention, the guide housing 19 that guides the rotation of the drive shaft 20 about its axis A1 is pivot mounted with respect to the bearing body 12 about an axis A2 which is orthogonal to the axis A1 of the drive shaft 20.

For that purpose, as illustrated schematically in the figures, the housing 19 of the reduction gearbox 18 which supports the electric motor 16 comprises two cylindrical pivot pins 22 which are transversely opposed and aligned along the axis A2.

Each pivot pin 22 is mounted to rotate in a guide hole 24 formed in the bearing body 12. Thus, the housing 19 of the reduction gearbox 18 which supports the electric motor 16—and therefore the geared motor unit 14 as a whole—is mounted to pivot freely, about the axis A2, with respect to the bearing body 12.

By way of nonlimiting example, the axis A2 of pivoting of the housing 19 with respect to the bearing body 12 and the axis A3 of rotation of the output shaft of the electric motor 16 are coplanar.

In order to cause the geared motor unit 14 as a whole and, therefore, the drive shaft 20, to pivot with respect to the bearing body 12—according to the angular position of the drive shaft 10 about its axis of rotation A1—the drive device 10 comprises a mechanism 26 of the rack 30 and pinion 28 type.

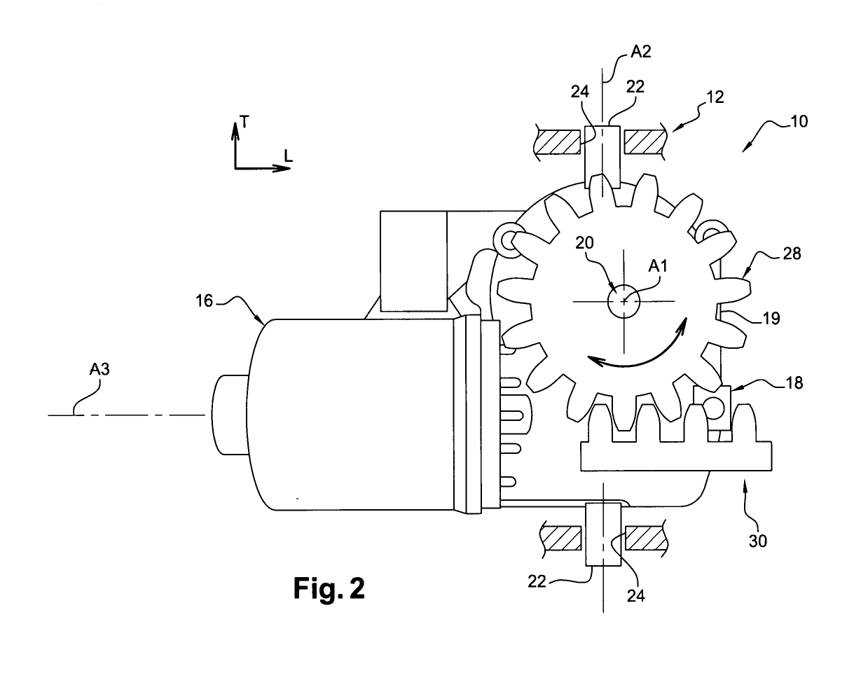

The pinion 28 is supported here by the drive shaft 20 to which it is rotationally connected in both directions as indicated by the arrow in FIG. 2.

The pinion 28 here is a pinion with straight-cut teeth which extends in a plane perpendicular to the axis A1.

The rack 30 here is a fixed rack which is fixed to a part 13 of the bearing body 12 as indicated schematically in FIG. 1.

The rack 30 is designed to complement the tooth set of the pinion 28 and is positioned in space with respect to the latter in such a way that the pinion 28 is always in mesh with the rack 30.

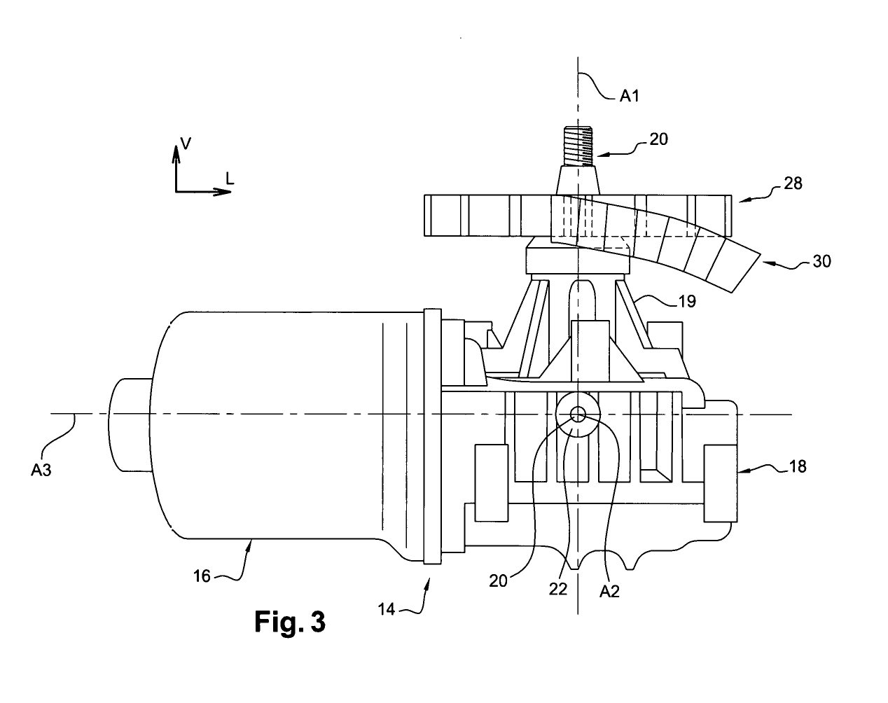

For that purpose and as can be seen particularly in FIG. 3, the rack 30 has a profile in the shape of an arc of a cylinder about the axis A2 of pivoting of the housing 19 of the reduction gearbox 18 of the geared motor unit 14 with respect to the bearing body 12 to which the rack 30 is fixed.

Because the rack 30 is fixed, through mechanical reaction, as soon as the drive shaft 20 is rotationally driven in one direction or the other, about its axis A1, by the electric motor 16, the engagement between the tooth set of the pinion 28 and the complementary tooth set of the fixed rack 30 causes the housing 19 to be driven in pivoting about the axis A2.

The rack and pinion mechanism thus allows control over the “inclination” of the axis A1 of the drive shaft 20 with respect to the bearing body 12.

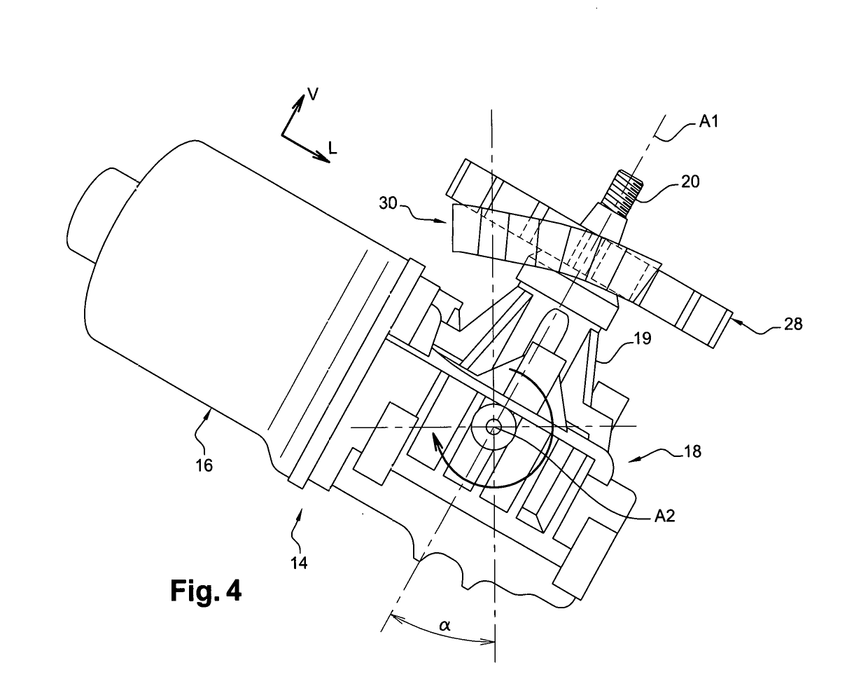

This is illustrated in FIG. 4 where it may be seen that the axis A1 of the drive shaft 20 has been inclined by an angle α—about the axis A2—with respect to its initial position illustrated in FIG. 3.

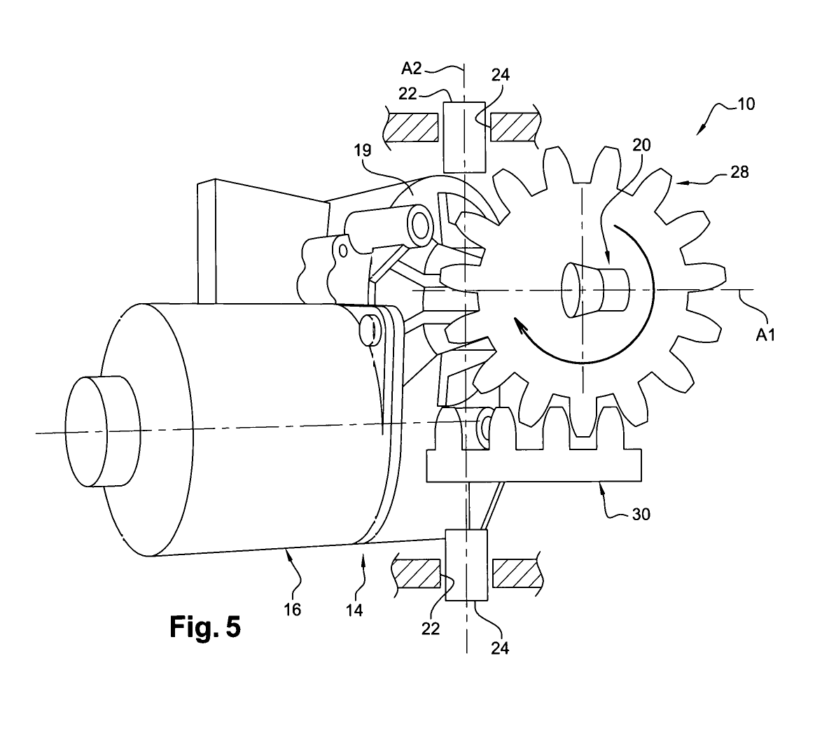

This same variation in inclination by an angle α can also be seen by comparing FIG. 5 with FIG. 2.

The reversal of the direction of rotation of the electric motor 16 and therefore of the drive shaft 20 causes the pinion 28 a relative rotation with respect to the rack 30 in the other direction, and therefore causes the housing 19 of the reduction gearbox 18 of the geared motor unit 14 to pivot in the other direction with respect to the bearing body 12.

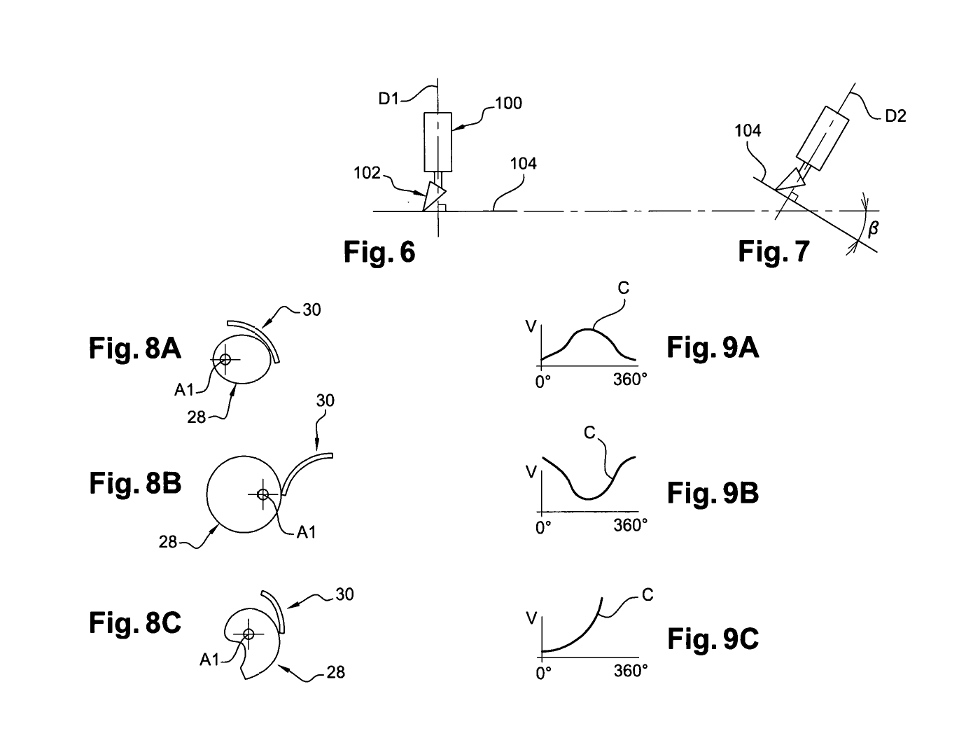

FIGS. 6 and 7 schematically depict the effect obtained on the quality of wiping by the pivoting and inclination movements of the drive shaft 20.

A wiper 100 supported by the wiper arm driven back and forth by the drive shaft 20 and bearing a wiper blade 102 for wiping the exterior surface 104 of a wiped window such as a curved windscreen has been depicted schematically.

When the inclination of the drive shaft 20 corresponds for example to the position of the components and elements in FIGS. 1 to 3, the wiper 100 is in a central zone of the windscreen and the wiper 100 with the wiper blade 102 extends overall in a direction D1 which is locally orthogonal to the plane of the exterior surface 104 of the windscreen.

As the wiper 100 sweeps across the surface of the curved windscreen through the rotational driving of the wiper arm it may, as illustrated in FIG. 7, reach another zone of the windscreen in which, locally, the exterior surface 104 forms an angle with respect to the zone 104 previously swept and wiped.

Thanks to the pivoting and to the inclination obtained of the axis A1 of the drive shaft 20, the wiper 100 with the wiper blade 102 extends overall in a direction D2 which is locally orthogonal to the plane of the exterior surface 104 of the windscreen.

In terms of alternative forms of design for the rack 30 and pinion 28 assemblies illustrated in FIGS. 8A, 8B and 8C, FIGS. 9A, 9B and 9C schematically depict the variation in the angular velocity of pivoting “V” as a function of the angle of rotation of the pinion 28.

In the first example of FIGS. 8A and 9A, the pinion 28 is elliptical in shape with its axis of rotation more or less corresponding to one focus.

In the second example in FIGS. 8B and 9B, the pinion 28 is a circular pinion with straight-cut teeth, but its drive axis is eccentric.

In the third example in FIGS. 8C and 9C, the tooth set of the pinion 28 extends along a logarithmic curve.

In each instance, the pinion 28 is associated with a rack of complementary profile, notably so as to ensure permanent mesh and drive of the two components.

By way of alternative form which has not been depicted, the guide housing that guides the rotation of the drive shaft 20 could be designed without angle gearing, namely with the drive shaft 20 parallel to the axis A3, for example in the form of an end cap of the electric-motor housing.

1. A drive device for driving the two-directional rotation of a windscreen wiper, which comprises:
a bearing body;
a drive shaft which is mounted to rotate about an axis with respect to the bearing body;
a guide housing for guiding the drive shaft in rotation about the axis which is pivot-mounted with respect to the bearing body about an axis which is orthogonal to the axis of rotation of the drive shaft;
a drive motor for driving the two-directional rotation of the drive shaft about the axis of rotation;
a mechanism which causes the drive shaft to pivot to vary the inclination of the axis of rotation of the drive shaft with respect to the bearing body according to the angular position of the drive shaft about the axis of rotation, wherein the drive motor is supported by the guide housing.

2. The drive device according to claim 1, wherein the guide housing houses transmission elements which convert the rotation of an output shaft of the motor into a rotational movement of the drive shaft about the axis of rotation.

3. The drive device according to claim 2, wherein the drive motor is an electric motor.

4. The drive device according to claim 2, wherein the output shaft of the drive motor is orthogonal to the drive shaft.

5. The drive device according to claim 2, wherein the orthogonal axis of pivoting of the guide housing with respect to the bearing body and an axis of rotation of the output shaft of the drive motor are coplanar.

6. The drive device according to claim 1, wherein the mechanism comprises a pinion which is supported by the drive shaft to which it is rotationally connected, and a complementary rack which is supported by the bearing body.

7. The drive device according to claim 6, wherein the rack is fixed with respect to the bearing body.

8. The drive device according to claim 6, wherein the transmission ratio between the pinion and the rack varies according to the angular position of the pinion with respect to the rack.
